(19) United States
(12) Patent Application Publication
(10) Pub. No.: US 2017/0174418 A1
(43) Pub. Date: Jun. 22, 2017

(54) A Beverage Cup for Coffee or the Like

(71) Applicant: Edward Z. CAI, Camas, WA (US)

(72) Inventor: Edward Z. CAI, Camas, WA (US)

(21) Appl. No.: 15/330,360

(22) PCT Filed: Mar. 12, 2015
(86) PCT No.: PCT/US2015/000038

§ 371 Date: Sep. 12, 2016

(51) Int. Cl. B65D 85/804; B65D 53/02; A47J 31/06; B65D 43/14

(52) U.S. Cl. CPC B65D 85/8043; B65D 43/14; B65D 53/02; A47J 31/0668

(57) ABSTRACT

A cup comprises a container having a flat bottom wall pierceable by a needle, a filter has a flat filter bottom supported on or sufficiently close to the flat bottom to allow the needle to push part of the flat filter bottom upwards to form a beverage collection chamber, a lid having an outer sidewall and a sloped inner sidewall to transform the brewing pressure in the cup into radial outward force acting on the outer sidewall to impart rigidity to the lid during brewing, and a pressure sensitive adhesive O-ring between the horizontal wall of the lid and the container rim. The cup may comprise a pressurization chamber enclosed by the outer sidewall, inner sidewall and a top film and adapted to become pressurized and expanded when hot water is injected into the cup, thereby imparting rigidity to the lid and improving the seal to the container.

### FIELD OF THE INVENTION

This invention relates to a beverage filter cup or cartridge to be filled or pre-filled by users at their homes or shops with flavor-containing material like coffee, tea, cocoa or apple cider.

### BACKGROUND OF THE INVENTION

The beverage cartridge taught by Sylvan et al in U.S. Pat. Nos. 5,325,765 and 5,840,189 has gained widespread acceptance under K-Cup® brands as a result of its convenience and speed, notwithstanding several problems that have persisted since its introduction about 20 years ago. One such problem is the limited amount of ground coffee the cartridge can hold, making coffee too weak for some. Sweeney et al. in U.S. Pat. No. 6,645,537 taught to solve this problem by sealing a filter to a tapered circular ledge located lower in the cup. This problem may also be solved by replacing Sylvan's conical filter with a cup-shaped filter 20 in cup 10A shown in FIG. 1A. The top end 17 of the sidewall 21 of the filter 20 is joined to the top sidewall 16 of the container 19. The periphery 14 of a cover film 11 is permanently heat sealed to the rim 15 of the container to seal coffee 12. An empty space 24 of almost 1 inch tall is formed below the flat filter bottom 23 to prevent the sharp tip 31 of a needle 29 on bottom wall 27 of cup holder 28 from breaking the filter bottom when cup 10A is fully inserted into holder 28. Needle 29 is designed to pierce bottom wall 25 for beverage to flow out via channel 30. Neither solution, however, fully utilizes the space in the cup for ground coffee due to the tall empty space 24.

Another problem is that Sylvan's cartridge takes away from consumers the control on what and how much ground coffee to use. To address this, numerous refillable filter cups such as Ekobrew™, Café Cup™ and Solofill™ Cup taught by Vu in US Pat. Appl. Publication 2013/0017303 have been provided. Such filter cup, represented as 10B in FIG. 1B, typically has a cup-shaped filter 20 formed in container 19 and the empty space 24 is tall enough to prevent filter bottom 23 from being punctured by needle 29. A rigid lid 41 has a rubber O-ring 42 positioned on sidewall 43 to seal to the sidewall 16 of container 19. An opening 45 is formed at the center of the lid to receive a water injection needle (not shown) from a brewer and a plate 47 with several holes 44 for distributing water from the injection needle to ground coffee 12. Though such filter cup allows consumers to use their own coffee grounds, it cannot hold enough ground coffee for a strong or large cup of coffee either. Such filter cup is also time consuming and messy to fill and clean, especially in the morning when both coffee and time are equally precious, which negates the convenience and speed of K-Cup® brewing.

To make the cleaning easier, Simple Cup™ offers a disposable filter paper that fits into the filter cups. However, the filter paper further reduces the amount of the coffee the filter cup can hold. Simple Cup™ also provides separate containers, lids and a stand tool to allow users to assemble a filter cup by placing a filter paper into a container, filling coffee, and then pushing a lid hard into the container with the support of the stand tool. This process is even more difficult and slower than the process of using the filter cups of FIG. 1B. In addition, since there is no seal between the lid and container in the assembled filter cup, the coffee cannot stay fresh and the lid is prone to slip out of the container to cause coffee grounds to sputter all over during dropping and storage.

The first objective of the invention is to provide a new beverage cup that is not only as convenient and fast to use as K-Cups® but also gives consumers the freedom to choose their own roast, brand and amount of ground coffee as the refillable filter cups do.

The second objective of the invention is to provide a new beverage cup that can allow consumers to fill in up to 50% more ground coffee as K-Cups® or the refillable filter cups.

The third objective of the invention is to provide a new beverage cup that can save consumers up to at least 50% cost compared to the cost of K-Cups®.

The last objective of the invention is to provide a new cup that is both re-usable when a user desires cost savings more and disposable when a user desires convenience more.

### SUMMARY OF INVENTION

The beverage cup or cartridge of the present invention includes an impermeable cup-shaped container having a flat bottom wall pierceable by a beverage outlet needle in the holder of a brewer and a cup-shaped filter has a flat filter bottom supported on the flat bottom wall or positioned sufficiently close to the flat bottom to allow the needle to push part of the flat filter bottom upwards to form a beverage collection chamber. Unlike the large and tall built-in beverage collection chamber in the prior-art K-Cups or reusable filter cups, the beverage collection chamber of the present invention is not present prior to the brewing operation, thus allowing the beverage cup of the present invention to be able to hold up to 50% more ground coffee. The beverage cup further comprises a lid that has an outer sidewall smaller than the opening of the cup-shaped container to allow the lid to move into and out of the container almost freely to facilitate the closure of the container and a pressure sensitive adhesive O-ring positioned between the horizontal peripheral wall of the lid and the horizontal rim of the cup-shaped container. The cup-shaped container and lid are made of very thin wall to minimize the material use and enable the cup to be disposable and reusable per the user's wish. The lid further comprises a sloped inner sidewall to transform the brewing pressure in the cup into radial outward force acting on the outer sidewall of the lid to impart the strength and rigidity to the thin walled lid during the brewing operation to prevent deformation of the outer sidewall of the lid, thus preventing hot water leakage.

In an alternative embodiment the beverage cup further comprises a ring-shaped pressurization chamber enclosed by the outer sidewall, inner sidewall and a top film sealed to the lid. The pressurization chamber is at ambient pressure prior to brewing and becomes pressurized and expanded in volume when hot water is injected into the beverage cup by the water inlet needle of the brewer, thus imparting rigidity to the thin walled lid and acting as an O-ring to improve the seal to the container.

### BRIEF DESCRIPTION OF THE DRAWINGS

The accompanying drawing illustrates diagrammatically non-limitative embodiment of the invention, as follows:

FIG. 1A is a vertical section view of a prior art beverage cup partially inserted in a holder;

FIG. 1B is a vertical sectional view of a prior art refillable cup partially inserted in a holder;

FIG. 2 is a vertical sectional view of a beverage cup partially inserted in a holder according to this invention;

FIG. 2A is a sectional view taken along line A-A of FIG. 2;

FIG. 2B is a vertical sectional view of the beverage cup of FIG. 2 before filled with ground coffee;

FIG. 3 is a vertical sectional view of an improved beverage cup of FIG. 2 partially inserted in a holder according to this invention;

FIG. 3A is a sectional view taken along line A-A of FIG. 3;

FIG. 3B is a vertical sectional view of the beverage cup of FIG. 3 before filled with ground coffee.

FIG. 4 is a vertical sectional view of an improved beverage cup of FIG. 3 partially inserted in a holder according to this invention;

FIG. 4A is a partial vertical sectional view of the beverage cup of FIG. 4 before the lid is sealed to cup and placed into the cup holder 28; and

FIG. 5 is a vertical sectional view of an improved beverage cup of FIG. 4 before the lid is sealed to cup.

### DESCRIPTION OF THE PREFERRED EMBODIMENTS

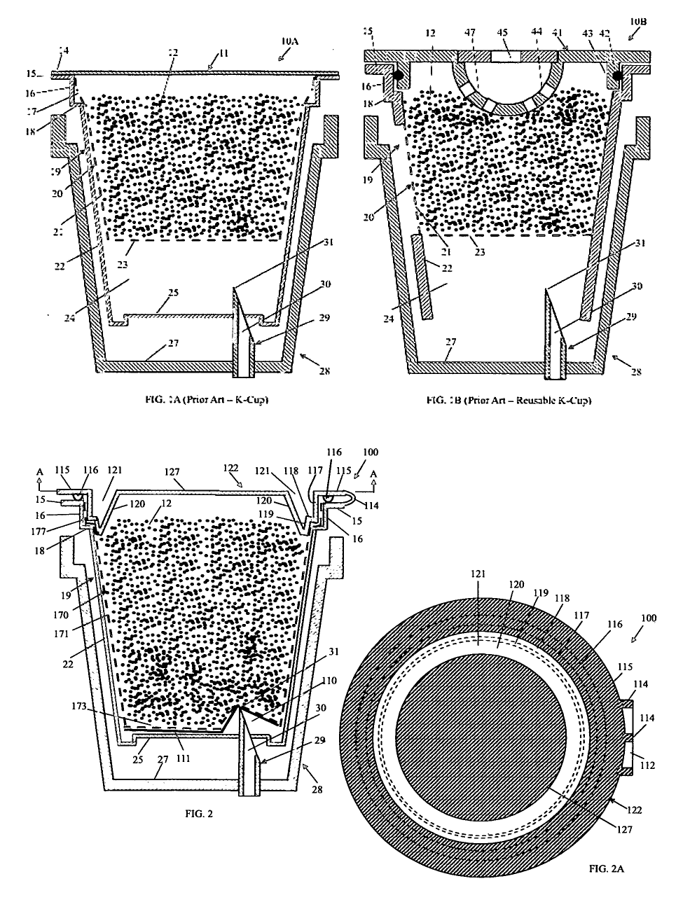

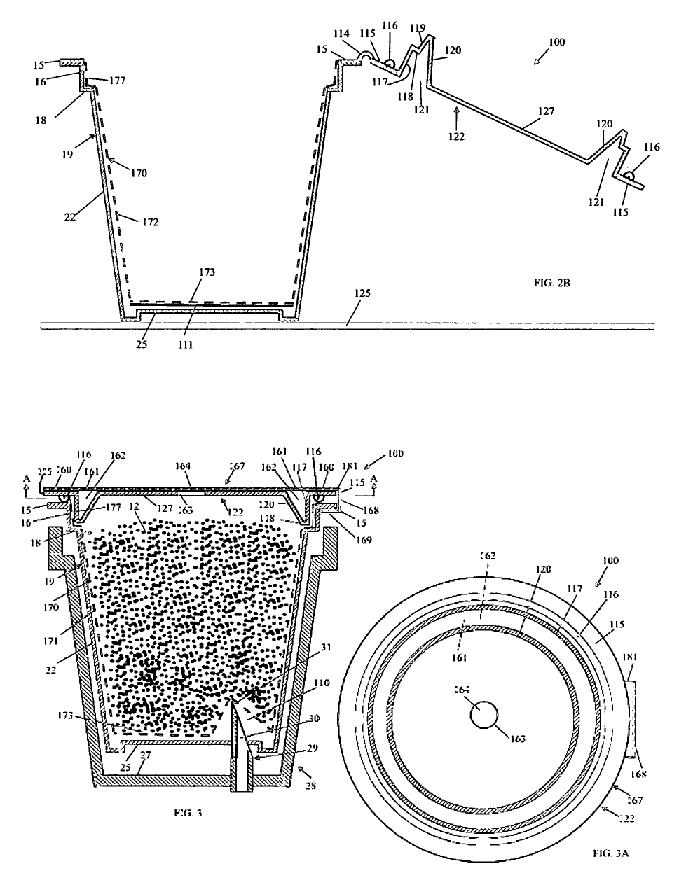

As illustrated in FIGS. 2 to 2B, a beverage filter cup or cartridge 100 of the present invention includes an impermeable container 19, a filter 170 and an impermeable lid 122. The parts that are similar to those in the prior art drawings of FIGS. 1A and 1B are assigned the same reference numbers for simplicity. Container 19 is preferably cup-shaped and has a gradually tapering truncated conical impermeable lower sidewall 22, an impermeable upper sidewall 16, a step 18 between the lower and upper sidewalls, a substantially flat impermeable bottom wall 25 pierceable by beverage outlet needle 29, and a radially outwardly protruding rim 15 surrounding a circular access opening for receiving flavor-containing material 12 such as ground coffee, tea, cocoa or other flavor-containing materials. The outlet needle is located at the bottom 27 of holder 28 of a brewer and has a sharp tip 31 for piercing the bottom wall 25 and a beverage outlet channel 30.

The filter 170 is cup-shaped and comprises an upper filter sidewall 177 permanently joined to an interior surface of the upper sidewall 16, a lower filter sidewall 171 and a closed substantially flat filter bottom 173 to define a storage chamber to store the flavor-containing material 12, shown in FIGS. 2 and 2B. Unlike the filter bottom 23 of filter 20 in the prior art shown in FIGS. 1A and 1B, the flat filter bottom 173 of the current invention has a substantially flat elastomer film 111 attached to the filter bottom 173 and is located on or sufficiently close to the bottom 25 of the container 19, thus maximizing the volume or capacity of the storage chamber for holding the flavor-containing material 12. It was found that the storage chamber of the beverage filter cup 100 can hold up to 50% more flavor-containing material 12 than prior-art filter cups 10A and 10B shown in FIGS. 1A and 1B.

Unlike the large and tall built-in beverage collection chamber 24 in the prior-art K-Cup 10A or reusable filter cup 10B as shown in FIGS. 1A and 1B, the beverage collection chamber 110 of the present invention is almost non-existent prior to the insertion of the filter cup 100 into holder 28. The beverage collection 110 is formed in the filter cup 100 when the bottom wall 25 of container 19 is pierced by outlet needle 29 and the outlet needle pushes part of the filter bottom 173 upwards. The collection chamber 110 increases in size as more of the needle 29 penetrates through the bottom wall 25 and reaches a maximum size after the cup 100 is fully inserted into holder 28. The elastomer film 111 makes the filter bottom 173 piercing-resistant to the outlet needle. Other piercing-resistant sheet, either flexible or rigid, such as a polyolefin sheet or non-woven polypropylene film, may be attached to the filter bottom 173 to make filter bottom piercing-resistant.

It was found that when certain particularly selected materials are used for the filter 170 and the container 19, the upper filter sidewall 177 becomes invisible after the filter is sealed to the upper sidewall 16 of the container via either heat, ultrasonic, infrared or other energy. Such invisibility of the filter improves the seal between the container 19 and lid 122, make it easier to fill and clean the beverage cup, and make the cup look better. Known cup materials like polystyrene or polymeric laminate such as Product No. C150 of Winpak Portion Pack of Bristol, Pa. taught by Sylvan et al in U.S. Pat. Nos. 5,325,765 and 5,840,189 could not make the upper filter sidewall 177 invisible. It was also found that to achieve the invisibility, the filter 170 should also be made of the same or similar material as the container 19. The materials that meet such conditions are polyethylene and polypropylene. The lower filter sidewall 171 is pleated to facilitate the flow of the beverage out of the closed chamber defined or formed by the filter bottom 173, filter sidewall 171 and lid 122. Vertical channels (not shown) may be formed on the lower sidewall 22 and channels (not shown) may be formed on the bottom wall 25 of the container to improve flow of the beverage to the beverage collection chamber 110.

The lid 122 comprises a peripheral horizontal wall 115 above the rim 15 of the container, an impermeable center wall 127 pierceable by a water injection needle (not shown) from the brewer for introducing water into the container, and a circular channel 121 between the peripheral and center walls. The circular channel 121 comprises a first outer lid sidewall 117 receivable in the access opening defined by the top sidewall 16 of the container, a second outer lid sidewall 119 receivable in the upper part of the sidewall 22 right below step 18, a step wall 118 to connect the first and second outer sidewalls, an inner sidewall 120 having one end connected to the center wall 127 and the other end connected to the second outer sidewall 119, and three flexible thin connectors or beams 114 to connect the rim 15 of the container 19 to the peripheral wall 115 of the lid. Space 112 is formed between the flexible beams 114.

Unlike the prior-art disposable K-Cup of FIG. 1A where the cover film 11 is permanently heat-sealed to the container 19 and unlike the reusable filter cup of FIG. 1B that can afford thick, rigid walls and rubber O-ring to achieve leak-proof seal during brewing under high pressure, the lid 122 of the present invention needs to use thin walls as thin as 0.01 inches to be disposable as the user wishes and needs to be movable to allow users to add ground coffee into container. As a result, lid 122 is prone to hot water leakage during the brewing since its thin lid walls are very prone to deformation under the high brewing pressure. To improve the seal between the lid 122 and container 19, the inner sidewall 120 is sloped, preferably sloped at an angle smaller than 60 degrees relative to the first outer sidewall 117. Such sloped inner sidewall 120 transforms the brewing pressure inside the cup 100 into an outward radial force acting on the lower end of the first outside wall 117 to improve the rigidity of the thin walled lid 122 and the seal between the sidewalls 117 and 16. The second outer sidewall 119 is provided to further improve the seal between the lid and container during the brewing.

Unlike the prior-art cup 10B of FIG. 1B that uses a rubber O-ring 42 on sidewall 43 to achieve seal, lid 122 has a new food-safe, pressure sensitive adhesive O-ring 116 positioned on the underside of the horizontal peripheral wall 115 of the lid 122 as shown in FIG. 2. The pressure sensitive adhesive O-ring 116 readily adheres to the rim 15 of the container 19 when lid 122 is turned by connector 114 and placed on container 19. By having the pressure sensitive adhesive O-ring on the horizontal peripheral wall 115, no leakage was observed during the pressure brewing even if the first outer lid sidewall 117 is substantially smaller, e.g. 0.04 to 0.2 inches smaller, than the inner diameter of the upper sidewall 16 or the top access opening of the container 19. With the lid sidewall 117 smaller than the top access opening, little or no force is needed to press the lid into the container after the user fills the cup with ground coffee, thus making the sealing operation effortless.

The lid with lid sidewall 117 smaller than the top access opening is also critical to the successful preparation of the beverage cups when consumers fill and seal the cups at homes. For the cup 100 to be disposable, the sidewalls 16 and 22 of the container 19 are also very thin, e.g. thinner than about 0.03 inches. Such thin sidewalls cannot withstand the force needed to press the lid sidewall 117 into the top access opening if the lid sidewall 117 is about the same as or larger than the top opening of the container 19. The lid with the smaller sidewall 117 can be pressed into the top access opening with little or no force, thus preventing the container 19 from collapsing when the user presses the lid into the container to seal the ground coffee 12 in the storage chamber defined or formed by the filter side wall 171 and filter bottom 173.

Though the beverage cup 100 uses very minimum amount of materials through the use of very thin walled lid 122 and container 19 and can be disposable like K-Cups®, the more cost or environment conscious users may still wish to reuse the beverage cup 100. In order to allow one to reuse the cup 100, we discovered that by using hydrophilic pressure sensitive adhesive to make the O-ring, the O-ring could lose its adhesion after the brewing operation. Such loss of adhesion after brewing makes it possible for the user to open the lid, dispose the used grounds and clean the cup 10 for reuse. After the cup 10 becomes dry in air or by heat, the pressure sensitive adhesive O-ring re-gains its adhesion power to adhere and seal the lid to the container 19.

The pressure sensitive adhesives for making the O-Ring 116 may be a pressure sensitive hot melt such as HMA-221-A from the Glue Factory, Germantown, Wi or a pressure sensitive emulsion such as AA-4080 from the same company. It was found for the cup 100 to work, the height of the pressure sensitive adhesive O-ring 116 needs to be about 0.1 millimeters to 2 millimeters, preferably 0.2 millimeters to 1 millimeter. As shown in FIG. 2B, the inner perimeter of the pressure sensitive adhesives O-Ring 116 is located close to or at the outer sidewall 117 to prevent the O-ring from falling off or being transferred to the rim 15 of the container after the lid is sealed to the container 19 and than removed from the container. Various textures, roughness, protrusions, recessions, channels and ridges may be provided on the underside surface where the pressure sensitive adhesive O-Ring is located to prevent then O-ring from falling off the underside surface or being transferred to the rim during the sealing and removal of the lid. The pressure sensitive adhesive O-ring 116 requires no release or protection paper. When the O-ring 116 gets dirty with dusts or coffee particles, it can be easily cleaned with rinsing water to cause it to lose adhesion power and it can then regain its adhesion power by letting it dry in air.

The container 19 and lid 122 with thin walls can be thermoformed from thin sheets of plastics. Though the beverage cup 100 in the preferred embodiments has a round cup shape, it is appreciated that the cup may adopt an oval, square, rectangular, diamond and other shapes. It is appreciated that the pressure sensitive adhesive O-ring may adopt shapes other the round and may be used in other applications. It is also appreciated that the cup may be used without filter 20 if the flavor-containing material 12 is cocoa, milk powder, soup powder, apple cider, or any edible matters that can be consumed with or without the addition of water.

FIGS. 3 to 3B show an improved embodiment of the beverage cup 100 of FIG. 1. The improved cup has a substantially ring-shaped pressurization chamber 162 receivable in the access opening of the container 19 and connected to the lid for preventing leakage during brewing. The pressurization chamber comprises the outer sidewall 117 of the lid for engaging the impermeable upper sidewall 16 of the container 19, inner sidewall 120 of the lid in contact with the hot fluid during the brewing, a top film ring 161 and a chamber bottom 118 connected to the inner and outer sidewalls. It is under ambient pressure prior to brewing and becomes pressurized during brewing when the hot water injected into the cup 100 from a water injection needle (not shown) of the brewer heats up the air in the chamber. The pressure in the pressurization chamber pushes the outer sidewall 117 radially outwards to improve the seal to the upper sidewall 16 of the container 19 and imparts rigidity to the thin walled lid 122. The film ring 161 is part of a substantially circular film 167 and is heat sealed to the top end of the outer sidewall 117. The outer peripheral section 160 of the film 167 is sealed to the peripheral wall 115 of the lid 122. The film ring 161 may also be heat sealed to the top end of the inner wall 120 to make the ring-shaped chamber airtight to allow pressure to build up therein as hot water from the water inlet needle heats up the air in the ring-shaped chamber and to prevent hot fluid above the flavor-containing materials from entering said ring-shaped chamber.

The cup-shaped filter 170 is made from non-woven polypropylene and container 19 and lid 122 is also made from polypropylene so that consumers can recycle all the propylene material in the filter and container after washing out the used coffee grounds. In the effort to make the beverage cup completely recyclable, it was discovered that the beverage collection chamber 110 could be formed without the elastomer film 111 of FIG. 2 attached to the flat bottom 173 of the filter when a nonwoven filter made from elongated long polymer fibers of polyolefin, polyester, nylon or the like polymers.

A protection opening 163 is formed at or near the center of the impermeable center wall 127 to prevent the beverage cup 100 from getting stuck to the brew head (not shown) of the brewer and causing damage to the brewer when the user opens the brew head to dispose the used beverage cup. The protection opening is covered by the center film 164 of the film 167 to prevent oxidizing air from reaching the material 12 after the lid 122 is sealed to the container 19. To prevent water leakage during the brewing, the protection opening is made at least 3 times as large in diameter as that shown in FIG. 3 in an alternative embodiment of the present invention (not shown). The enlarged protection opening 163 in this alternative embodiment occupies at least 40% of the area of the impermeable center wall 127.

An issue with the beverage cup 100 of FIG. 2B is that the lid 122, despite its very light weight that is typically less than 5 grams, often causes the container 19 to tilt and fall when the user places the beverage cup on table or countertop, which makes it inconvenient and difficult to fill the cup with ground coffee. One solution is to provide a separate container 19 and lid 122, though this requires the user to store and handle two separate parts. An improved solution is shown in FIG. 3B where one end of the lid 122 is connected to the rim 15 of the container 19 via a section of low-memory film connector 168 and the free end, which is opposite to the connected end, is at about the same height as the bottom 25 of the container 19. This allows the free end of the lid 122 to be supported on the table or countertop when the beverage cup is placed on the table or countertop. The low-memory film connector 168 has little memory of its previous shape and can be an aluminum foil or paper based film that can stay at a current shape without influenced by its previous shape or an ultra flexible film that can bend freely by the weight of the lid 122 lighter than 5 grams. To prevent the lid 122 from moving out of the access opening of the container 19, the length of the film connector 168 is substantially larger than the total thickness of the rim 15 and the outer peripheral wall 115.

To use, one grinds ¼ to 1 pound of fresh roasted coffee beans of one's favorite brand, places 12 to 48 beverage cups 100 on table or countertop with the free end of the lid 122 also supported on the table or countertop, dispenses or scoop 8 to 15 grams of ground coffee into each cup depending on one's preference for coffee strength and volume, and flips the lid 122 over the container 19 to cause the pressure sensitive adhesive O-ring 116 to seal to the rim 15 of the container airtight to keep the ground coffee fresh. Such pre-filled coffee cups 100 can be used later just like K-Cups®.

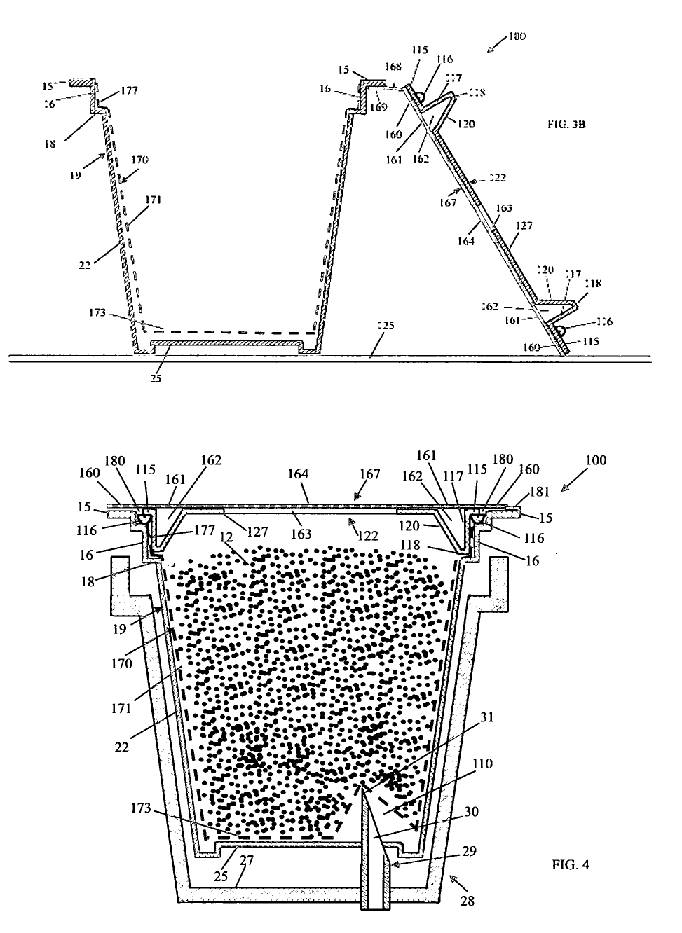

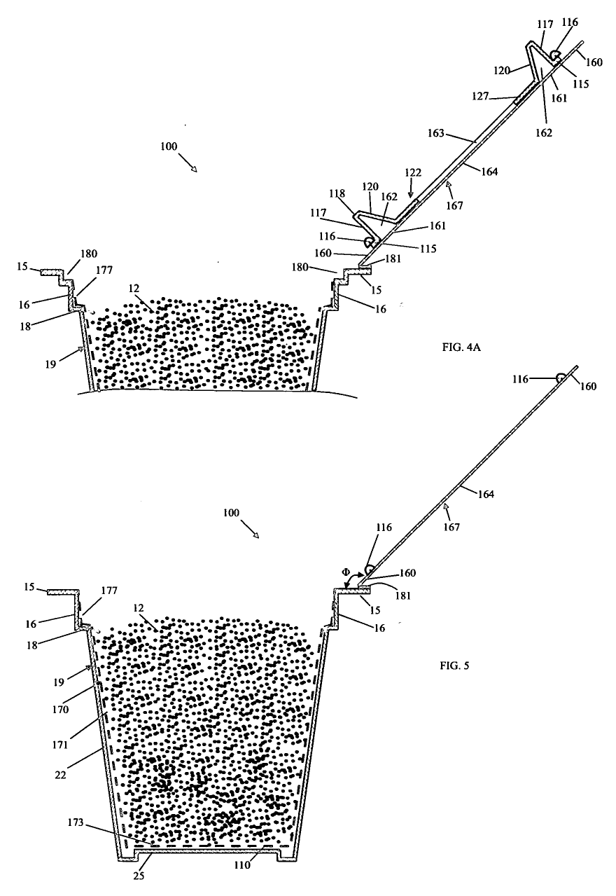

FIGS. 4 and 4A show a second improved embodiment of the beverage cup 100 of FIG. 2. In the improved cup, the radially outwardly protruding peripheral wall or rim 115 outside the first outer lid sidewall 117 of the lid 122 is shortened to make the width of this shortened rim 115 substantially narrower than the rim 15 of the cup-shaped container 19. The lid 122 is heat sealed to the flexible film 167 and connected to the container 19 by heating sealing a small part 181 of the film 167 to a part of the rim 15. The outer peripheral section 160 of the film 167 extends outwards to cover the rim 15 of container 19 when the container is sealed. The flexible outer peripheral section 160 of the film 167 prevents accidental opening when the cup 100 falls to hard ground or contacts other objects. Moreover, The flexible outer peripheral section 160 prevents any potential tampering of the content in the cup since when one tries pull it to open the lid 122, the film will be broken at or near its heat seal to the lid 167, which makes the cup 41 unusable and serves as a warning sign that the cup has been tampered. However, the steam heat or water during brewing makes the lid 122 removable after the cup 100 is brewed, which makes it possible to re-use the cup or remove the waste grounds for better recycling.

A recess 180 is formed on the rim 15 around the access opening of the container 19 and is dimensioned to receive the shortened rim 115 so that the bottom surface of shortened rim 115 is substantially below the top surface of the cup rim 15. It was found that when the recess 180 was sufficiently deep to cause the top surface of the shortened rim 115 to be at least about leveled with or even below the top surface of the rim 15 of the container 19, the adhesion force is significantly increased to make the lid 167 nearly impossible to open unless the cup 100 was brewed with hot water in the brewer.

It was also found that by making the diameter of the protection opening 163 larger than one third of the diameter of the lid 122, preferably larger than half the diameter of the lid, the freshness and aroma of the ground coffee sealed in the cup 100 is greatly improved after 3 to 6 months of storage time. It is theorized that the larger opening 163 prevents air from entering the chamber when the room temperature or pressure changes during day and night. It was also found that the freshness and aroma of the ground coffee sealed in the cup 100 is greatly improved by making adhesive O-ring 116 sufficiently fluidic to cause the adhesive to wick when the container 19 is closed by lid 122. It was further found that the freshness and aroma of the ground coffee sealed in the cup 100 is greatly improved when the adhesive O-ring 116 includes a layer of the adhesive on the outer surface of the first outer lid sidewall 117.

It was discovered that the cup 100 of FIGS. 4 and 4A worked without water leakage during the brewing even if the lid 122 was not heat sealed to the flexible film 167, as shown in FIG. 5. The flexible outer peripheral section 160 of the film 167 is connected to the container 19 by heating sealing a small part 181 of the film 167 to a part of the rim 15 of the container 19. The flexible film 167 should be sufficiently rigid to form a proper filling and sealing angle Φ for the cup. The angle Φ should be between 90 to 265 degrees to enable proper filling and sealing of the cup by coffee filling equipment. The peripheral section 160 of the film 167 is sealed to the rim 15 by either the adhesive O-ring 160 or heat seal. The filter bottom 173 is substantially flat and is sufficiently close to or even in contact with the bottom wall 25 of the container 19 to form an extra large containing or filter chamber formed by the pleated side filter 171 and the closed bottom filter 173. The beverage collection chamber 110 has zero or near zero-volume, but it is adapted to expand in volume during the brewing process to facilitate the extraction of the materials in the filter chamber and the flow of beverage out of the cup.

It is appreciated that by locating the filter bottom 173 close or in contact with cup bottom 25, the current invention has avoided the “water channeling” problem common in K-Cups®, which occurs because the water jet from the brewer produces a large center pathway between the water inlet needle in the brewer and the filter bottom 23 and causes most water from the brewer to pass through the filter bottom 23 (FIGS. 1A and 1B) directly without contacting the ground coffee. It is also appreciated that the beverage filter cup 100 may adapt a square shape to reduce its need for storage and transportation space. It is also appreciated that the beverage outlet needle 29 may be solid without the channel 30 and the beverage outlet is formed between the outer surface of the needle and the punctured hole at the bottom 25 of the container 19.

Although specific features of the present invention are shown in some drawings and not in others, this is for convenience only as some feature may be combined with any or all of the other features in accordance with the invention. The foregoing description has been limited to a specific embodiment of the invention. It will be apparent, however, that variations and modifications can be made to the invention, with the attainment of some or all of the advantages of the invention. Therefore, it is the object of the appended claims to cover all such variations and modifications as come within the true spirit and scope of the invention.

What is claimed is:

1. A beverage filter cup to be filled with a supply of flavor-containing material by a user comprising:
a cup-shaped container having an impermeable sidewall, a closed bottom wall, and a radially outwardly protruding rim surrounding an access opening for receiving the flavor-containing material, said bottom wall being pierceable by a beverage outlet needle in a cup holder of a brewer;
a filter having a top part joined to an interior surface of said impermeable sidewall, a filter sidewall, a closed filter bottom and a storage chamber defined by said filter sidewall and closed filter bottom to store the supply of flavor-containing material received through said access opening, said filter being adapted to allow the beverage to pass through and flow out of said container via the beverage outlet needle;
a lid having an impermeable center wall, a substantially horizontal peripheral wall adapted to cover said outwardly protruding rim of said cup-shaped container and a connector for connecting a part of said substantially horizontal peripheral wall to said outwardly protruding rim, said impermeable center wall being pierceable by a water inlet needle of the brewer to receive water into said storage chamber for combination with said flavor-containing material to produce a beverage, said connector being adapted to allow said lid to turn from a first position in which said access opening is open and a second position in which said access opening is closed; and
wherein said lid is away from said access opening to allow a user to add a supply of flavor-containing material into said storage chamber and is placed on said container by the user to cause said lid sidewall to enter said access opening and said horizontal peripheral wall to cover said outwardly protruding rim, thereby forming an airtight seal for the supply of flavor-containing material.

2. The beverage filter cup of claim 1 wherein said filter is cup-shaped with a substantially flat and closed filter bottom, said closed substantially flat filter bottom being located so close to said closed bottom wall of said container that the beverage outlet needle of the brewer can push said closed filter bottom upwards when said cup is inserted into the cup holder of the brewer, said beverage filter cup further comprising a beverage collection chamber between said bottom wall of said container and said closed substantially flat filter bottom, said beverage collection chamber is adapted to increase in size as more of the outlet needle penetrates through said bottom wall of said container and reaching a maximum size after said beverage filter cup is fully inserted into the holder.

3. The beverage filter cup of claim 2 further comprising a piercing-resistant sheet attached to said substantially flat filter bottom, thereby making said filter bottom piercing-resistant to the beverage outlet needle.

4. The beverage filter cup of claim 2 wherein said filter comprises a non-woven film made of elongated polymer fibers resistant to piercing by the beverage outlet needle.

5. The beverage filter cup of claim 1 wherein said lid further comprises a lid sidewall receivable in said access opening of said container and adapted to surround said impermeable center wall to be pressed into said access opening of said container and a pressurization chamber receivable in said access opening and connected to said lid sidewall for preventing leakage during brewing, said pressurization chamber being normally under ambient pressure and becoming pressurized during brewing when the hot water injected into said storage chamber from the water injection needle heats up the air in said pressurization chamber, said lid sidewall being pushed radially outwards against said impermeable sidewall of said container by the pressure in said pressurization chamber to form a leak-proof seal.

6. The beverage filter cup of claim 1 wherein said lid further comprises a substantially ring-shaped chamber receivable in said access opening of said container for preventing leakage during brewing, said substantially ring-shaped chamber comprising said lid sidewall, a chamber bottom connected to said lid sidewall, an inner sidewall having one end connected to said chamber bottom and the other end connected to said impermeable center wall, a substantially ring-shaped space defined by said lid sidewall, chamber bottom and inner sidewall, and a film ring sealed to said lid sidewall for covering said substantially ring-shaped space.

7. The beverage filter cup of claim 6 further comprising a substantially circular film, said circular film comprising an outer peripheral section sealed to said peripheral wall of said lid, a center film located above said impermeable center wall of said lid, and said film ring between said center film and outer peripheral.

8. The beverage filter cup of claim 6 wherein said film ring is sealed to the top end of said inner sidewall, thereby making said substantially ring-shaped chamber airtight to allow pressure to build up therein as hot water from the water inlet needle heats up the air in said ring-shaped chamber.

9. The beverage filter cup of claim 1 wherein said lid further comprises a protection opening located near the center of said impermeable center wall and a substantially circular film sealed to said impermeable center wall to cover said opening, thereby preventing said beverage filter cup from getting stuck to the brew head of the brewer and causing damage to the brewer.

10. The beverage filter cup of claim 9 wherein said protection opening is made sufficiently large to occupy at least 40% of the area of said impermeable center wall, thereby preventing leakage during brewing.

11. The beverage filter cup of claim 1 wherein said lid is connected to said container by a film connector, said film connector having one end attached to said outwardly protruding rim of said container and the other end attached to said peripheral wall of said lid, the length of said film connector being substantially larger than the total thickness of said rim and outer peripheral wall to prevent said lid from moving out of said access opening of the container.

12. The beverage filter cup of claim 1 further comprising a flexible connector for connecting a first end of said lid to said outwardly protruding rim of said container, said lid being positioned at a predetermined angle relative to said container to cause the free end of said lid, which is opposite to said first end, to be at about the same height as said bottom wall of said container during storage and use of said beverage filter cup, thereby preventing said container from tilting or falling when a user places said beverage filter cup on a table or countertop and adds flavor-containing material into said container.

13. The beverage filter cup of claim 12 wherein said flexible connector is a low memory film selected from a group comprising a laminated aluminum foil film, a laminated paper film, a coated paper film and an ultra flexible film that is able to bend substantially freely by a weight lighter than 5 grams.

14. The beverage filter cup of claim 1 wherein said lid further comprises an inner sidewall having one end connected to said lid sidewall and the other end connected to said impermeable center wall and a substantially ring-shaped channel between said lid sidewall and inner sidewall, said inner sidewall being sloped at an angle smaller than 60 degrees relative to said lid sidewall to transform the brewing pressure in said beverage cup into an outward force acting on said lid sidewall, thereby improving the seal between said lid sidewall and said impermeable sidewall of said container.

15. The beverage filter cup of claim 1 further comprising a pressure sensitive adhesive O-ring positioned on the underside of said horizontal peripheral wall of said lid, said pressure sensitive adhesive O-ring readily adhering to said outwardly protruding rim of said container, thereby significantly speeding up the sealing operation of said beverage filter cup.

16. The beverage filter cup of claim 15 wherein said lid sidewall is substantially smaller than said access opening of said container and little or no force is needed to press said lid sidewall into said container, thereby making the sealing operation of said beverage filter cup effortless.

17. The beverage filter cup of claim 15 wherein said pressure sensitive adhesive O-ring is adapted to lose adhesion to said outwardly protruding rim of said container after the brewing operation, thereby allowing a user to readily open said lid, dispose the used coffee grounds and clean said beverage filter cup for reuse, said pressure sensitive adhesive O-ring being further adapted to re-gain its adhesion power after being dried in air or by heat.

18. The beverage filter cup of claim 17 wherein said pressure sensitive adhesive O-ring is made from a hydrophilic pressure sensitive adhesive.

19. The beverage filter cup of claim 15 further comprising at least one of texture, roughness, protrusion, recession, channel and ridge on the underside surface where said pressure sensitive adhesive O-Ring is located, thereby preventing said pressure sensitive adhesive O-Ring from falling off said underside surface or being transferred to said rim during the sealing and removal of said lid.

20. The beverage filter cup of claim 1 wherein said filter sidewall is pleated to facilitate the beverage flow and wherein a predetermined height of said pleated filter sidewall is sealed to a predetermined height of said impermeable sidewall of said container, said filter and said container being made from polypropylene to make said predetermined height of said pleated filter sidewall invisible.

21. A cup to be filled with cocoa, soluble coffee, lemonade powder, milk powder, soup powder, apple cider, strawberry or other products by a user comprising:
a cup-shaped container having an impermeable sidewall, a closed substantially flat bottom wall, and a radially outwardly protruding rim surrounding an access opening for receiving the product;
a lid having a lid sidewall receivable in said access opening of said container, an impermeable center wall surrounded by said sidewall for closing said access opening, and a substantially horizontal peripheral wall adapted to cover said outwardly protruding rim when said lid sidewall is pressed into said access opening of said container; and
a pressure sensitive adhesive O-ring positioned on the underside of said horizontal peripheral wall of said lid, said pressure sensitive adhesive O-ring readily adhering to said outwardly protruding rim of said container, thereby significantly speeding up the sealing operation of said cup.
